(19) United States
(12) Patent Application Publication
(10) Pub. No.: US 2003/0055724 A1
(43) Pub. Date: Mar. 20, 2003

(54) Method and apparatus for creating a database of individuals for permission-based marketing and communications purposes

(76) Inventors: Jeffrey J. Battin, Wexford, PA (US); Kate A. Hallock, Bradford Woods, PA (US); William Hallock, Bradford Woods, PA (US)

Correspondence Address: METZ LEWIS, LLC, 11 STANWIX STREET, 18TH FLOOR, PITTSBURGH, PA, 15222, US

(21) Appl. No.: 09/961,136

(22) Filed: Sep. 20, 2001

(51) Int. Cl. G06F 17/60

(52) U.S. Cl. 705/14

(57) ABSTRACT

The present invention provides a method and apparatus for creating lists of names, addresses, such as e-mail addresses, and other information for individuals who have granted permission for one or more organizations to contact them. A plurality of attendees attend an event using an event access document having a unique value thereon to gain access to the event. Attendees are urged by various means of communication to visit a particular web site, or other similar facility capable of collecting the information desired by a sponsor. In exchange for providing a minimum amount of information regarding the attendee, the site or facility will determine if the attendee has been awarded a prize or other item of value, based on the unique value provided by that attendee.

### FIELD OF THE INVENTION

The present invention relates to a method and apparatus for creating a database for permission based marketing, and in particular to a method and apparatus for obtaining contact information for a plurality of individuals and permission to send information to those individuals. The database has particular application in promoting products and/or services to the individuals by sending information to them electronically, such as by e-mail, through an electronic network such as the Internet.

### BACKGROUND AND DESCRIPTION OF THE PRIOR ART

A vast array of interconnected networks formed over the last decade has become what is now known as the Internet. The Internet uses personal computers, servers, physical network medium and related equipment, protocols, application programs and associated programming languages to provide a variety of services to its users. Some examples of these services include the World Wide Web, commonly referred to simply as the Web, and electronic mail, commonly referred to as e-mail.

Communication addressing protocol on the Internet differs substantially from the conventional street addressing system. Specifically, e-mail services on the Internet use an address naming convention which takes the form of a user name, followed by an @ symbol, and then a host name. This type of address is commonly referred to as an e-mail address. An example of such an e-mail address is gsmith@anycompany.com. The Web, on the other hand, uses an addressing convention that utilizes what is referred to as a Uniform Resource Locator or URL. A URL is used to identify a particular web server on the Internet, and is normally preceded by www. Often the name of an organization or other entity is included in the URL. An example of a URL is www.sportscompany.com.

The Internet presently uses a client/server concept to carry out the majority of its work, including its Web and e-mail services. This concept is client-centric, wherein the client makes requests to a server and the server responds accordingly. For example, in the case of Internet e-mail service, a client composes an e-mail message on a client computing device such as a personal computer and sends it to an e-mail server, thereby requesting the server to deliver the message through the Internet to the designated recipient. Likewise with the Web, a client requests pages of information from a server, and the server sends the pages back to the client, using the Internet as its communications channel.

The client application program that individuals use to communicate with servers on the Web is referred to as a browser. One example of a browser in wide use today is Internet Explorer® distributed by Microsoft Corporation of Redmond, Wash. Servers use a web-specific programming language known as hyper text markup language, or HTML, to send requested pages back to a browser. HTML controls how the text and graphic content of each page is displayed on the client computing device. Additionally, through the use of Active Server Pages or other similar web-specific technologies, a user is able to communicate information to a server where it is stored in one or more databases, such as a relational database, within that server. Often, these databases are used for marketing purposes, and hence many are referred to as marketing databases. The stored database information may be used by an entity having a server to compose and send on request web pages to an individual operating a browser on a client computing device that contain particular information directed to that individual.

Because of its widespread use as a means of communication, businesses are increasingly using the Internet to market or sell their products directly to consumers. One reason businesses are turning to the Internet to market their products is the fact that the incremental cost of sending promotions using the Internet is extremely low in comparison to conventional communication channels such as direct mail, radio and television commercials, and telemarketing. In the case of Internet marketing, there are no expensive printing or postage costs and, unlike traditional printed and mailed pieces, the information can be communicated to the consumer almost instantaneously.

Another advantage of using the Internet to sell products is the fact that, through the use of marketing database technology, communications can be specifically tailored to the intended recipient, thereby making messages more relevant and thus more effective. The practice of tailoring messages to a particular consumer is known as Customer Relationship Management or CRM. When used in conjunction with the Internet, this technique is referred to as electronic CRM or eCRM.

Despite the advantages of using the Internet as a marketing tool, its effectiveness for this purpose has been undermined by a practice commonly known as spamming. Spamming is the mass transmission of unsolicited e-mails to consumers. Both consumers and professional marketing organizations decry the practice of spamming as a nuisance. In response to the widespread use of spamming, the concept of permission-based or Opt-In marketing has developed. As the name implies, permission-based marketing techniques target only those consumers who have specifically granted permission for businesses to send them e-mail. At the moment, Opt-In e-mail practices are completely voluntary. It is anticipated, however, that they will become mandatory in the near future.

Due to the relative youth of the Internet, comprehensive listings of e-mail addresses have not been accurately or extensively compiled. The few listings that do exist are expensive, and do not generally contain permission for a specific business to send communications to those individuals listed therein. Thus, a major challenge facing organizations desiring to exploit the power of the Internet for productive, professional communications with Internet users is in compiling, updating, and growing such lists of e-mail addresses, and in particular lists of individuals that have granted permission to that organization to contact them by e-mail.

### SUMMARY OF THE INVENTION

The present invention provides a method and apparatus for creating lists of names, addresses, such as e-mail addresses, and other information for individuals who have granted permission for one or more organizations to contact them through, for example, the Internet such as by e-mail, or otherwise.

A sponsor is an organization or individual which desires to utilize the present invention to enhance its marketing position, or for other business objectives and the event manager is an organization or an individual that is responsible for bringing together groups of individuals for a particular purpose, such as a sporting event, concert or other cultural event where such individuals, called event attendees, are required to have a unique ticket or other satisfactory event access document to gain entrance to the event. In accordance with the present invention, each event access document is provided with a unique value thereon.

Attendees at the event are urged by various means of communication to visit a particular web site, or other similar facility capable of collecting the information desired by the sponsor. In exchange for providing a minimum amount of information regarding the attendee and the unique value included on the event access document used by the attendee, the site or facility will determine if the attendee has been awarded a prize or other item of value, based on the unique value provided by that attendee.

The database information generated by the method and apparatus of the present invention are then used to undertake communications with the attendee by the sponsor or other party appropriately authorized. Such communications may take the form of advertising, promotions, or other marketing activities, or product or service information exchange, or any other communications deemed desirable by the sponsor.

According to one embodiment of the present invention, a method of collecting contact information for a plurality of individuals and permission to contact the individuals includes issuing a plurality of event access documents each having a unique value provided thereon, the event access documents providing access to an event and providing notice to a plurality of attendees attending the event that the unique value provided on one or more of the event access documents may be used to collect a prize. The attendees are instructed to visit a specified website to determine prize eligibility. According to the method, information is collected from each of the attendees visiting the specified website. This information includes contact information for the website visiting attendee, a grant or denial of permission to contact the website visiting attendee, and the unique value provided on the event access document used by the website visiting attendee. At least a part of the collected information is stored in, for example, a relational database. Each of the website visiting attendees is informed of whether the unique value provided on the event access document used by the website visiting attendee entitles that website visiting attendee to collect a prize. The collected contact information may include one or more of an email address, a telephone number and a street address. The collected information may also be evaluated against variable criteria and/or duplicate criteria. Redemption information may be provided to each attendee entitled to receive a prize that informs the attendee of how the prize can be redeemed.

According to a further embodiment of the present invention, a method of collecting contact information for a plurality of individuals and permission to contact said individuals includes providing a website accessible over an electronic network and collecting information from each of a plurality of event attendees visiting the website, wherein the event attendees have each attended an event and have used an event access document having a unique value provided thereon to gain access to the event. The collected information includes contact information for the event attendee, a grant or denial of permission to contact the event attendee, and the unique value provided on the event access document used by the event attendee. At least a part of the collected information is stored, for example, in a relational database. Each of the event attendees is informed of whether the unique value provided on the event access document used by the event attendee entitles the event attendee to collect a prize. The collected contact information may include one or more of an email address, a telephone number and a street address. The collected information may also be evaluated against at least one of variable criteria, which specifies particular required or permissible information, and duplicate criteria, which protects against the entry of duplicate information. Redemption information may be provided to each attendee entitled to receive a prize that informs the attendee of how the prize can be redeemed. The website may include one or more registration web pages to facilitate collection of the information and/or one or more prize web pages for informing the event attendees of their prize, if any.

According to a still further embodiment of the present invention, an apparatus for collecting contact information for a plurality of individuals and permission to contact the individuals includes one or more servers hosting a website accessible over an electronic network. The website includes one or more registration web pages for collecting information from each of a plurality of event attendees, the event attendees having attended an event and having used an event access document having a unique value provided thereon to gain access to said event. The information includes contact information for the event attendee, a grant or denial of permission to contact the event attendee, and the unique value provided on the event access document used by the event attendee. The apparatus also includes a database provided in the one or more servers for storing at least a part of the collected information and an indication for each of the unique values of whether the unique value corresponds to a prize. The one or more servers informs each of the event attendees of whether the unique value provided on the event access document used by the event attendee corresponds to a prize. The collected contact information may include one or more of an email address, a telephone number and a street address. The collected information may also be evaluated against variable criteria and/or duplicate criteria provided in the one or more servers. Redemption information may be provided to each attendee entitled to receive a prize that informs the attendee of how the prize can be redeemed. The redemption data may include a hyperlink to a web page where the prize can be redeemed. The website may include one or more registration web pages to facilitate collection of the information or one or more prize web pages for informing the event attendees of their prize, if any.

According to a still further embodiment of the present invention, a method of collecting contact information for a plurality of individuals and permission to contact the individuals includes collecting information from each of a plurality of event attendees over an electronic network, the event attendees having attended an event and having used an event access document having a unique value provided thereon to gain access to the event. The information includes contact information for the event attendee, a grant or denial of permission to contact the event attendee, and the unique value provided on the event access document used by the event attendee. At least a part of the information for each said event attendee is stored, for example in a relational database. Each of the event attendees is informed over the electronic network whether the unique value provided on the event access document used by the event attendee entitles the event attendee to collect a prize. The collected contact information may include one or more of an email address, a telephone number and a street address. The collected information may also be evaluated against variable criteria or duplicate criteria. Redemption information may be provided to each attendee entitled to receive a prize that informs the attendee of how the prize can be redeemed.

According to a still further embodiment of the present invention an apparatus for collecting contact information for a plurality of individuals and permission to contact the individuals includes one or more servers accessible over an electronic network wherein the one or more servers are adapted to collect information from each of a plurality of event attendees, the event attendees having attended an event and having used an event access document having a unique value provided thereon to gain access to said event. The information includes an contact information for the event attendee, a grant or denial of permission to contact the event attendee, and the unique value provided on the event access document used by the event attendee. The apparatus further includes a database provided in the one or more servers, for example a relational database, for storing at least a part of the collected information and an indication for each of the unique values of whether the unique value corresponds to a prize. The one or more servers informs each of the event attendees over the electronic network whether the unique value provided on the event access document used by the event attendee corresponds to a prize. The collected contact information may include one or more of an email address, a telephone number and a street address. The collected information may also be evaluated against variable criteria and/or duplicate criteria provided in the one or more servers. Redemption information may be provided to each attendee entitled to receive a prize that informs the attendee of how the prize can be redeemed.

According to a still further embodiment of the present invention a method of collecting contact information for a plurality of individuals and permission to contact said individuals includes issuing a plurality of event access documents having a unique value provided thereon and providing notice to a plurality of attendees attending the event that the unique value provided on one or more of the event access documents may be used to collect a prize. The method further includes providing one or more servers coupled to an electronic network which are adapted to collect information from one or more information submitting attendees. The collected information includes contact information for the information submitting attendee, a grant or denial of permission to contact the information submitting attendee, and the unique value provided on the event access document used by the information submitting attendee. At least a part of the collected information is stored on the one or more servers and each of the information submitting attendees is informed over the electronic network of whether the unique value provided on the event access document used by the information submitting attendee entitles that information submitting attendee to collect a prize.

### BRIEF DESCRIPTION OF THE DRAWINGS

Further features and advantages of the present invention will be apparent upon consideration of the following detailed description of the present invention, taken in conjunction with the following drawings, in which like reference characters refer to like parts, and in which:

FIG. 1 is a block diagram of an embodiment of an apparatus according to the present invention;

FIG. 2 is a block diagram of an embodiment of an apparatus according to the present invention illustrating the display of a registration web page on an event attendee's computer;

FIG. 3 is a block diagram of an embodiment of a server forming part of an apparatus according to the present invention;

FIG. 4 is a block diagram of an embodiment of an apparatus according to the present invention illustrating the display of an information error web page on an event attendee's computer;

FIG. 5 is a block diagram of an embodiment of an apparatus according to the present invention illustrating the display of a duplicate value web page on an event attendee's computer;

FIG. 6 is a block diagram of an embodiment of an apparatus according to the present invention illustrating the display of a unique value web page on an event attendee's computer;

FIG. 7 is a block diagram of a an embodiment of a server forming part of an apparatus according to the present invention;

FIG. 8 is a block diagram of an embodiment of an apparatus according to the present invention illustrating the display of a unique value error web page on an event attendee's computer;

FIG. 9 is a block diagram of an embodiment of an apparatus according to the present invention illustrating the display of a prize web page on an event attendee's computer;

FIG. 10 is a block diagram of a database loaded on a server forming part of an apparatus according to the present invention;

FIG. 11 is a block diagram of an alternate embodiment of an apparatus according to the present invention that utilizes electronic mail communication between the server and an event attendee's computer;

FIG. 12 is a block diagram showing the personal information and communication information tables of a database loaded on a server forming part of an apparatus according to the present invention; and

FIG. 13 is a block diagram of a further alternative embodiment of an apparatus according to the present invention capable of reporting information to one or more authorized organizations.

### DESCRIPTION OF THE PREFERRED EMBODIMENTS

According to the present invention, an organization or an individual, referred to as the event manager, is responsible for bringing together groups of individuals for a particular purpose, such as a sporting event, concert or other cultural event. A sponsor is an organization or individual which desires to utilize a method or apparatus described herein to enhance its marketing position, or for other business objectives.

The event manager creates or causes to be created an appropriate quantity of event access documents, such as a ticket, that are to be used to gain access to the particular event in question. According to the present invention, each event access document has printed thereon a value that is unique to that event access document and that makes it distinct from all other event access documents for at least the event in question, and possibly for other events. The unique value may comprise, for example, the description of the particular seat assigned to that event access document such as by section, row and seat number or may comprise a unique number unrelated to the seat or the event venue, such as a bar or numerical code. The event access documents are then distributed in some manner, such as by sale, to individuals desiring to attend the event, known as event attendees. Such distribution may occur through the event manager, the sponsor or a third party. Each event attendee uses his or her event access document to gain authorized access to the event venue.

Event attendees are made aware that they may be eligible to receive a prize, such as an item of value or an offer having some value, for example a discount for the purchase of products or services, by visiting a specified website and providing certain information, including the unique value appearing on their event access document. As used herein, the phrase visiting a website shall mean using an electronic device such as a personal computer, a cell phone, a pager, or a personal digital assistant to request, receive and display one or more web pages of the website in question. Event attendees may be made aware of this information in many ways and at various times, including public address announcements made at the event venue, visual notification by a scoreboard or the like at the event venue, light displays or other such devices, signs and posters of various types, printed information distributed to the event attendees, including information printed on the event access document itself or notices provided in a newspaper or a mass mailing.

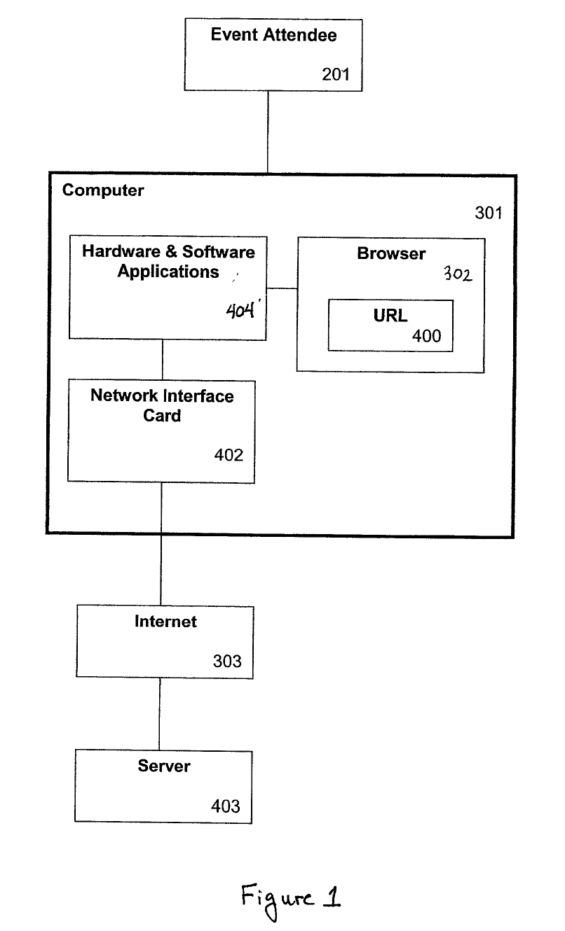

Referring to FIG. 1, event attendee 201 has access to computer 301 or any other electronic device capable of communicating through the Internet 303, such as a cell phone, a pager or a personal digital assistant. Computer 301 is provided with browser 302, which is the well known client software application used by computer 301 to communicate with servers over the Internet 303 and construct and display web pages on computer 301. After having attended the event in question, event attendee 201 visits the website specified in the information received by event attendee 201 while attending the event or at other times by entering URL 400 associated with the specified website into browser 302. Browser 302, in conjunction with conventional well known hardware and software applications 404 of computer 301, including an operating system such as Windows 98 or Windows 2000 distributed by Microsoft Corporation of Redmond, Wash., routes URL 400 through network interface card 402, and out through the Internet 303. While the preferred embodiment of the present invention contemplates use of the Internet 303, it should be appreciated that any public or private electronic network comprising a distributed computer network may be substituted for the Internet 303. The routing of URL 400 through the Internet 303 amounts to a request of server 403 identified by URL 400 to send back certain information to browser 302. Server 403 according to an embodiment of the present invention includes a server computer equipped with various components including a central processing unit such as a microprocessor, a non-volatile storage device such as a hard drive or drives, RAM, communications buses, device controllers and a network interface card and associated drivers wherein the server computer is provided with a suitable operating system such as a network operating system. Suitable examples of server 403 are the Dell Poweredge Model 2500, sold by Dell Computer of Round Rock, Tex., the HP Netserver E 800, sold by Hewlett Packard Company of Palo Alto, Calif., and the Sun Enterprise 6500, sold by Sun Microsystems, Inc. of Palo Alto, Calif. loaded with the Windows 9x series, Windows NT or Windows 2000 operating system sold by Microsoft Corporation of Redmond, Wash.

In addition, as described herein, server 403 is provided with and adapted to run certain commercially available software and certain custom written software to provide the functionality of the present invention. This software is preferably stored in the storage device of server 403. While a single server 403 is described herein, it should be appreciated that multiple servers 403 in communication with one another may be used. In such a configuration, the software and the functionality associated therewith may be spread among the various servers 403. For example, one server 403 may comprise a web server and provide the web pages described herein, while a second server 403 may provide the data storage and management functions described herein and will include database 602. Typically, a greater number of servers 403 will increase performance as the volume of information and use of the system increases. Furthermore, rather than the storage device of server 403 storing the data according to the present invention, it will be appreciated that a separate data storage device such as a commercially available storage array may be used, with the data stored therein being accessible by a server 403.

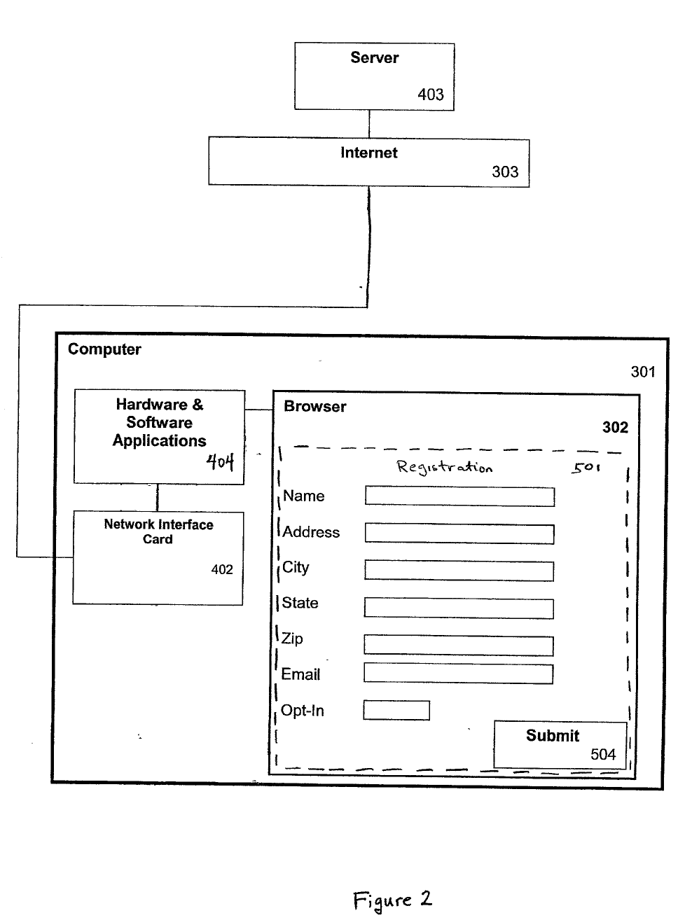

Referring to FIG. 2, in response to the request from computer 301, certain information, primarily consisting of HTML instructions and graphics information, is returned from server 403 to computer 301 through the Internet 303. The information is routed through network interface card 402 and hardware and software applications 404 and to browser 302. The HTML instructions and graphics information provided to browser 302 may be combined to create and display registration web page 501 on computer 301.

Custom written software for selecting and/or generating appropriate HTML instructions and graphics information for any purpose described herein is preferably stored in the storage device of server 403. As is known in the art, the software may be written in various programming languages such as the Visual Basic or SQL programming languages. As is also known in the art, all of the HTML instructions and graphics information may be in the form of prewritten templates that are adapted as needed prior to being transmitted to computer 301 for construction of an appropriate web page.

Registration web page 501 provides a template to be used by event attendee 201 to enter certain personal information into browser 302, such as the name, address, city, state, zip code and e-mail address of event attendee 201. The components of personal information to be entered may vary and may be specified by the sponsor and/or the event manager. In addition, event attendee 201 is requested to grant or deny permission for one or more organizations, such as the sponsor, to contact event attendee 201 such as by sending e-mail messages through the Internet 303 to event attendee 201. Some or all of the information requested in registration web page 501 may be required in order to proceed to collect the prize. By activating submit button 504, or other suitable control, provided on registration web page 501, all of the information entered by event attendee 201 is transmitted through hardware and software applications 404 and network interface card 402 of computer 301 over the Internet 303 to server 403.

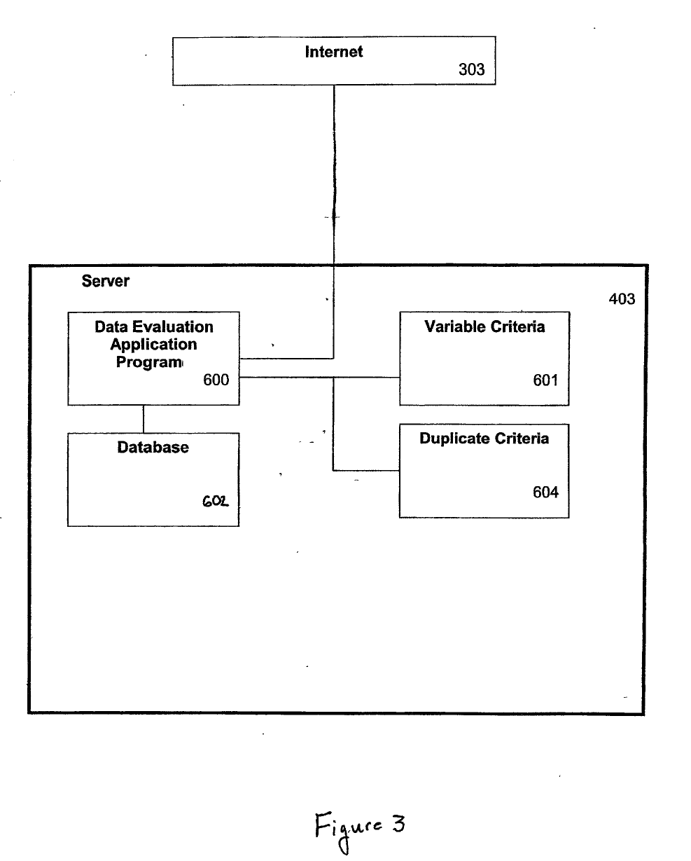

Referring to FIG. 3, a custom written software application referred to as data evaluation application program 600 is preferably stored in the storage device of server 403. Server 403 also includes database 602 preferably comprising a relational database management system or RDBMS preferably stored in the storage device of server 403 which, as is well known in the art, allows for the creation, maintenance and manipulation of one or more databases of information in the form of one or more interrelated tables of data. A suitable example of an RDBMS is the SQL Server® product distributed by Microsoft Corporation of Redmond, Wash. The data included in the one or more tables is preferably stored in the storage device of server 403.

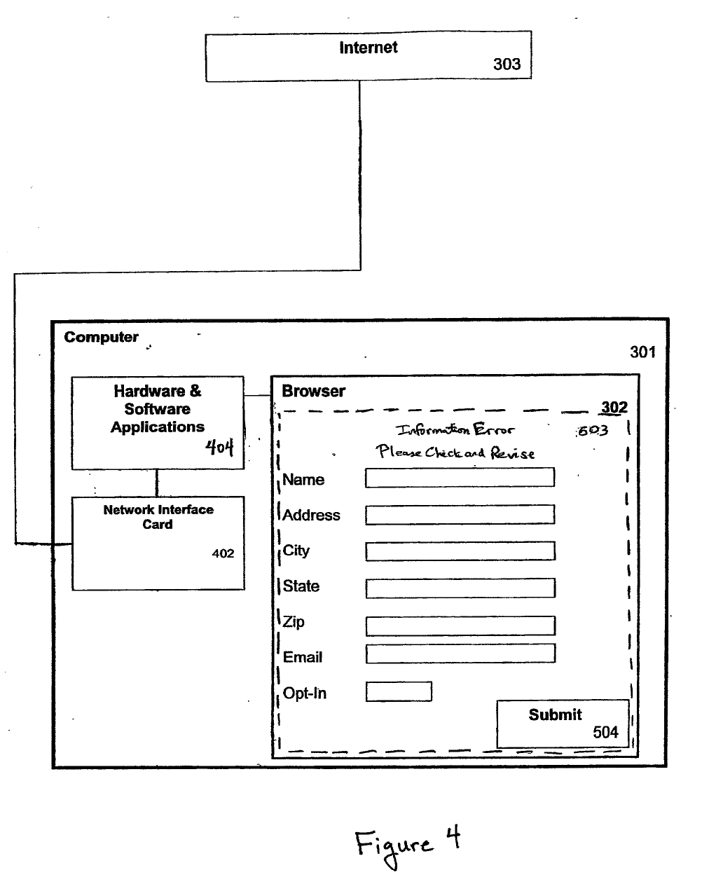

The information received through the Internet 303 by server 403 is evaluated by data evaluation application program 600. If the information does not satisfy certain variable criteria 601, which may be established by one or both of the event manager and the sponsor, as determined by data evaluation application program 600, then server 403 returns appropriate HTML instructions and graphics information for constructing information error web page 603, shown in FIG. 4, to computer 301 through the Internet 303.

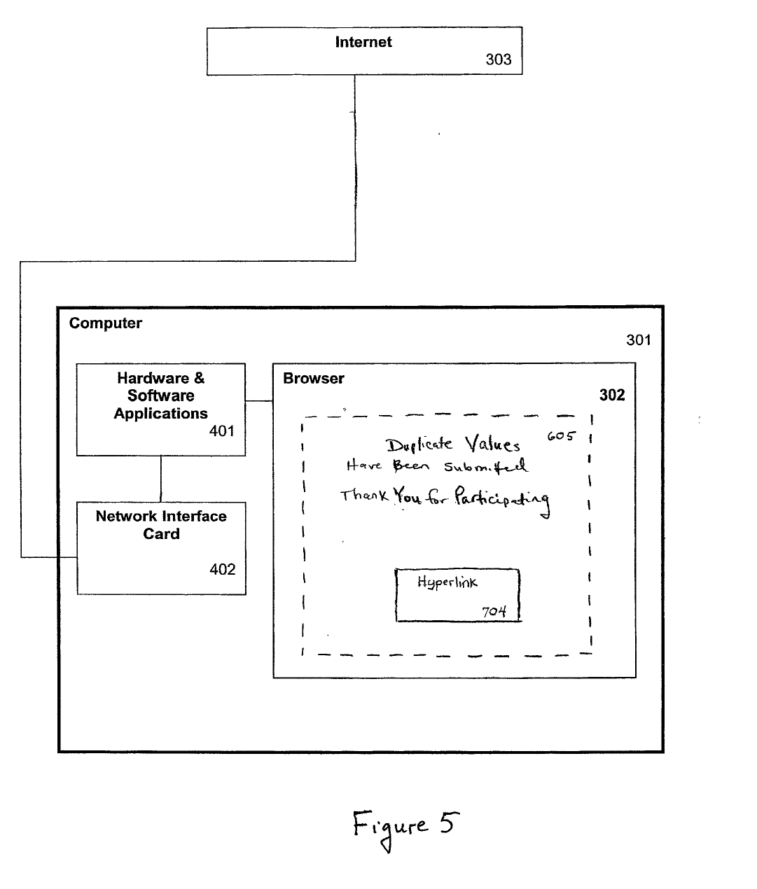

Variable criteria 601 may specify that certain information requested in registration web page 501 is required or that only certain input information will be acceptable, such as a range of valid zip codes in order to limit participants to a certain selected geographic area. Variable criteria 601 are programmed as part of data evaluation program 600. Certain aspects of variable criteria 601, such as a range of valid zip codes, may be stored in database 602. If the information satisfies variable criteria 601, then the information is examined by data evaluation program 600 against duplicate criteria 604 that specifies that one or more selected pieces of information may not be duplicated in database 602, for example a duplicate name, address, e-mail address, or unique value appearing on an event access document. In the event that any of the specified information is duplicated in database 602, server 403 returns appropriate HTML instructions and graphics information for constructing duplicate value web page 605, shown in FIG. 5, to computer 301 through the Internet 303. If the information submitted by event attendee 201 satisfies variable criteria 601 and does not contain any duplicate information as specified by duplicate criteria 604, server 403 stores the information in database 602.

FIG. 4 illustrates information error web page 603 as displayed on browser 302 of computer 301. Information error web page 603 contains the same elements as registration web page 501, with the exception of a request for event attendee 201 to check and revise the data. The defective data as determined by data evaluation application program 600, which may be highlighted or otherwise set apart in information error web page 603, may result from missing elements of required data. The defective data may also result from entered data failing to pass criteria range evaluations such as not falling within a set of predetermined valid zip codes or a range of valid unique numbers provided on the event access documents for the event in question. Event attendee 201 then corrects missing or inaccurate information, and by activating submit button 504, the corrected information is transmitted to server 403 through the Internet 303. This cycle of event attendee 201 submitting information to server 403, and server 403 returning information error web page 603 continues until event attendee 201 has entered and submitted information in a form and amount that satisfies variable criteria 601.

FIG. 5 illustrates duplicate value web page 605 as displayed on browser 302 of computer 301. Duplicate value web page 605 may include a message informing event attendee 201 of the fact that one or more duplicate values have been submitted, and thanking event attendee 201 for participating. In contrast to information error web page 603, submit button 504 is not provided on duplicate value web page 605, as no further participation by event attendee 201 is anticipated. Various hyperlinks 704 such as a hyperlink to the event sponsor's and/or event manager's home web page containing rules for the promotion or to the event sponsor's e-commerce website may be placed on duplicate value web page 605 for the event attendee 201 to select.

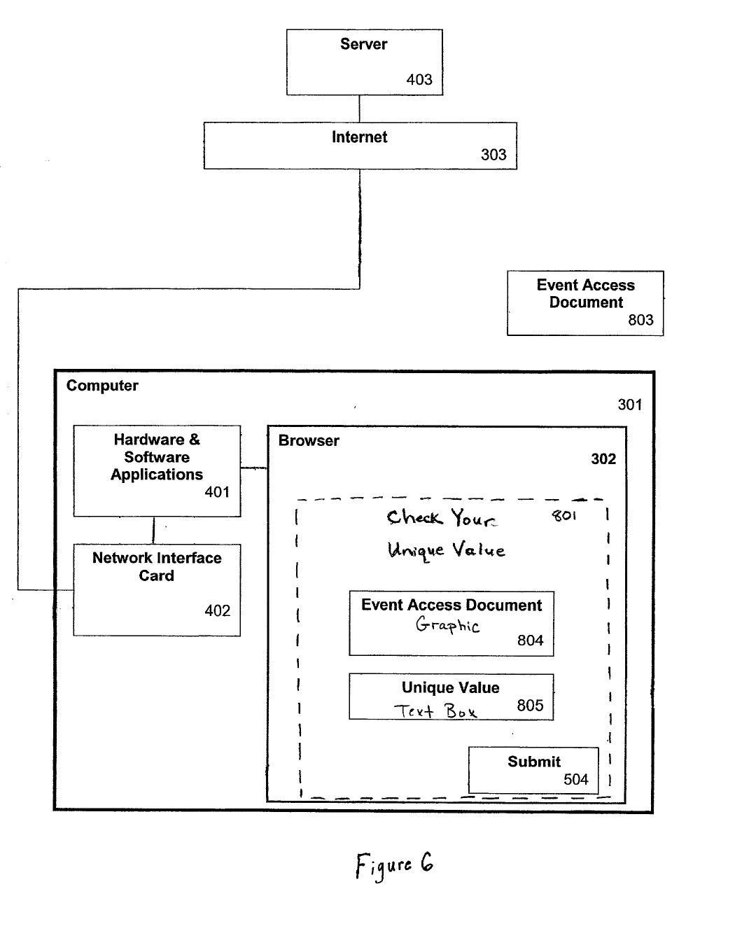

Referring to FIG. 6, when server 403 determines that the information submitted by event attendee 201 satisfies variable criteria 601 and does not contain any duplicate information as specified by duplicate criteria 604, server 403 transmits HTML instructions and graphics information for constructing unique value web page 801 of computer 301 through the Internet 303. The HTML instructions and graphics information are compiled by browser 302 into unique value web page 801 which is displayed on computer 301. Unique value web page 801 may be personalized with elements of the personal information of event attendee 201 stored in database 602 of server 403. Unique value web page 801 instructs event attendee 201 to examine his or her event access document 803 to determine the unique value found thereon. Unique value web page 801 may display graphic 804, which is a likeness of the event access documents for the particular event, to assist event attendee 201 in finding the unique value located on event access document 803. The actual unique value on event access document 803 is entered into appropriate text box or boxes 805 provided on unique value web page 801. The unique value may be any combination of numbers, letters and/or symbols, such as concatenation of a description of the assigned seat of event attendee 201, e.g. section, row and seat number, or a unique code not related to assigned seat location or the event in question. Activation of submit button 504 causes browser 302 to transmit the entered unique value over the Internet 303 to server 403.

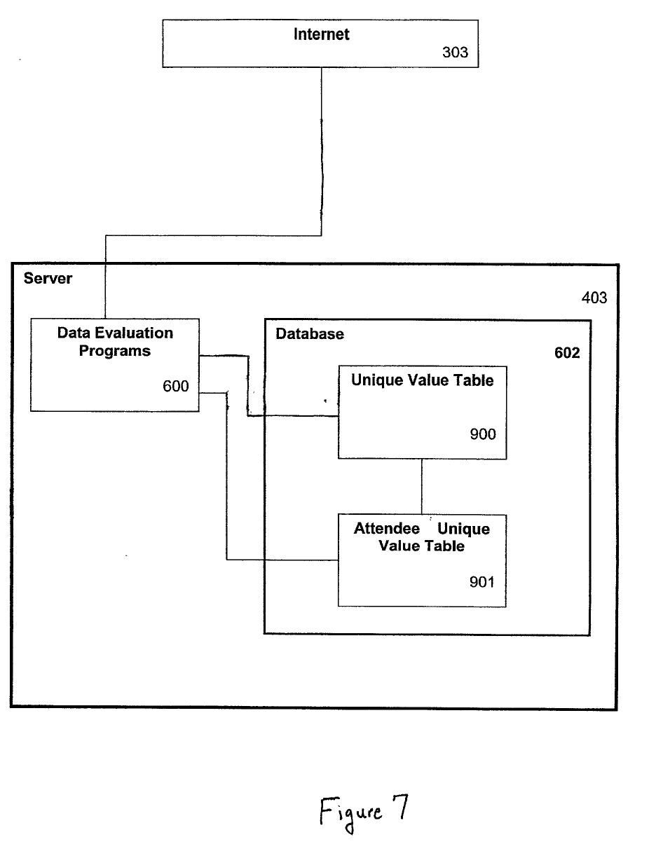

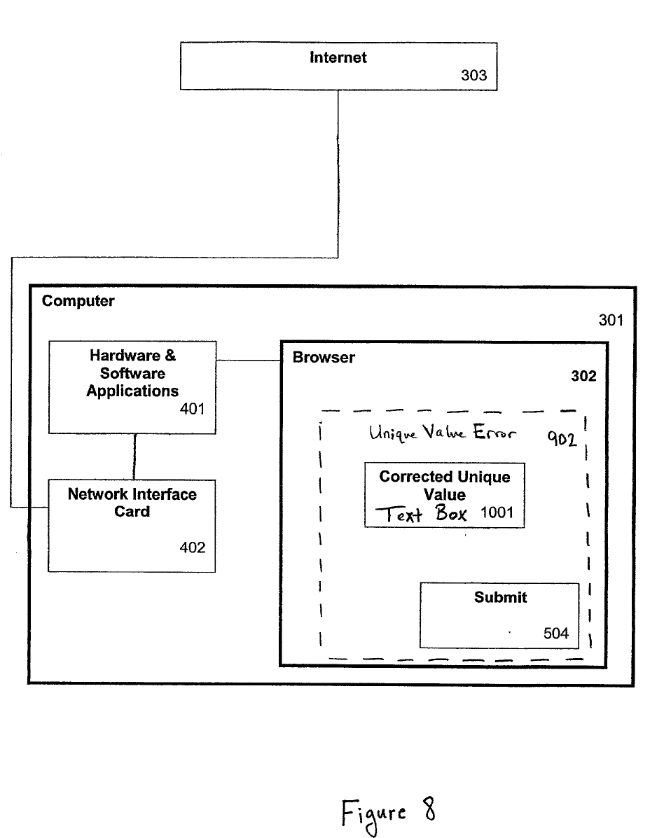

Referring to FIG. 7, when the unique value is received by server 403, data evaluation application program 600 evaluates the unique value by comparing it to a list of all possible unique values for the particular event stored in unique value table 900 of database 602. Unique value table 900 is preferably stored in database 602 prior to the event in question. If the unique value provided by event attendee 201 matches a unique value contained in unique value table 900, the unique value provided by event attendee 201 is accepted and stored in attendee unique value table 901 of database 602. Unique value table 901 may be used to later audit who entered each unique value. Should the unique value provided by event attendee 201 not match a unique value stored in unique value table 900, server 403 transmits appropriate HTML instructions and graphics information for constructing unique value error web page 902, shown in FIG. 8, to computer 301 through the Internet 303.

Referring to FIG. 8, unique value error web page 902 includes a request for event attendee 201 to check and revise the previously submitted unique value. Event attendee 201 corrects the previously submitted unique value by correcting incorrect data or providing missing data in text box or boxes 1001. By activating submit button 504, the corrected unique value is transmitted to server 403 through the Internet 303. The cycle of event attendee 201 submitting information to server 403, and server 403 returning unique value error web page 902 continues until the event attendee 201 has entered and submitted a unique value which matches a unique value contained in unique value table 900.

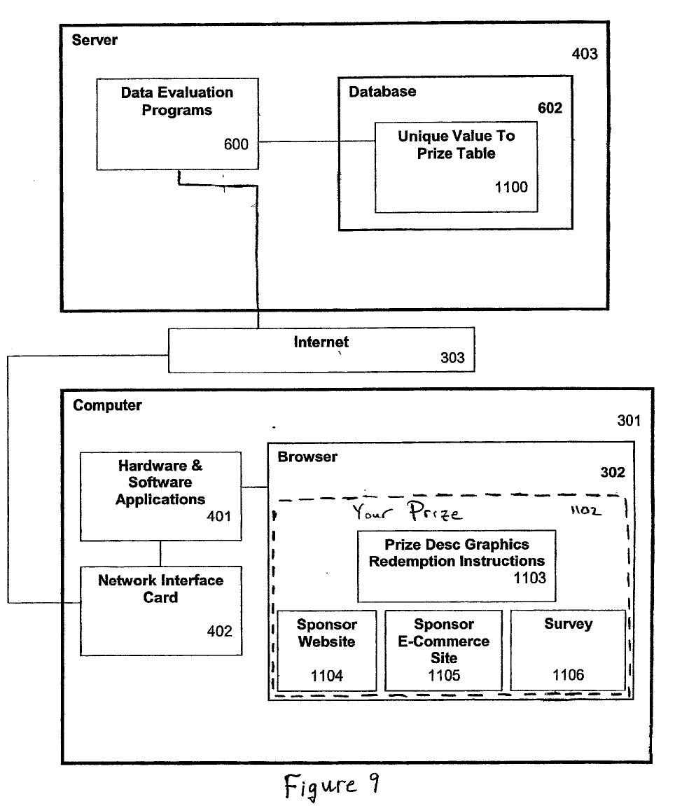

Referring to FIG. 9, when the unique value sent through the Internet 303 to server 403 by event attendee 201 is determined by data evaluation application program 600 to be identical to a unique value stored in unique value table 900, data evaluation application programs 600 utilizes unique value to prize table 1100 stored in database 602 to determine the prize, if any, associated with that unique value. In particular, unique value to prize table 1100 is compiled, such as randomly by chance, so that each unique value is stored along with a corresponding prize, if any. The unique value to prize table 1100 is searched to locate the unique value in question and the corresponding prize, if any. Based on the particular prize, if any, corresponding HTML instructions and graphics information are transmitted through the Internet 303 to computer 301. The HTML instructions and graphics information are compiled by browser 302 into prize web page 1102. Prize web page 1102 may contain a text description and/or graphic representation of the prize corresponding to the unique value, and instructions by which the event attendee 201 is able to redeem the prize, shown at 1103. Prize web page 1102 may also include one or more hypertext links 1104 to another web page such as one selected by the sponsor or the event manager, hypertext links 1105 to another web page where the prize may be redeemed online through the Internet 303, or hypertext links 1106 to a web page or pages containing an optional survey to be completed by event attendee 201. Event attendee 201 may be offered a prize or other consideration in return for completing the survey. If the survey is completed, the survey data may be returned to database 602 through the Internet 303 for storage therein. In the event that there is no prize associated with the unique value, prize web page 1102 will so indicate.

Database 602 is preferably a type of well-known database called a relational database. In a relational database, the data and relations between data are organized in what are known as tables. A table is a collection of one or more records, also referred to as rows, wherein each record in a given table contains two or more of the same data fields, also referred to as columns. Each table in a relational database typically stores data relating to a particular category. Information is normally stored in a relational database in the form of a number of sets of information wherein each set of information includes a record from one or more of the tables. The sets of information are assigned a unique identifier, such as a unique number. The unique identifier is a field in each of the records. Thus, the records making up the set that are stored in each of the tables are related by virtue of the common unique identifier. For example, a relational database may be used to store several pieces of information for a group of people. The information, organized into a number of records, for each particular person comprises a set for that person, and each set is given a unique identifier forming a part of each record. Thus, all of the information stored in the various tables of the database for a particular person is identified and related by that person's unique number.

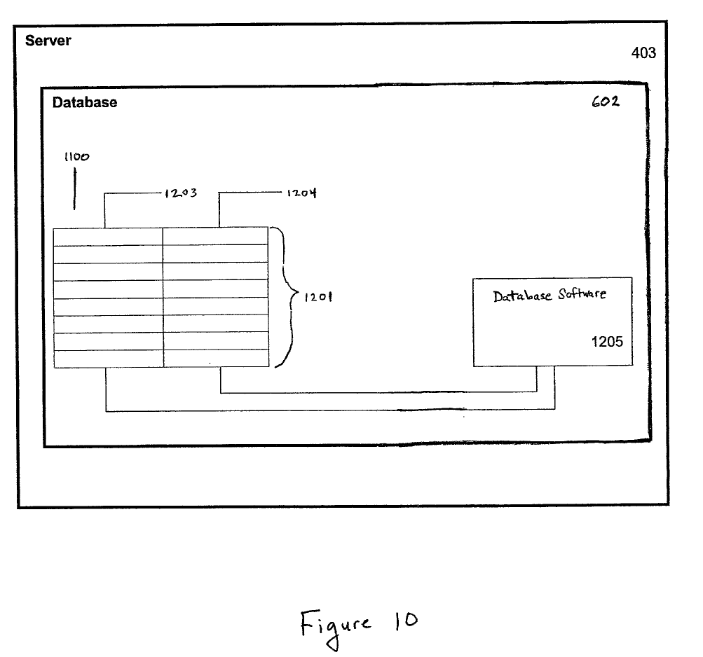

FIG. 10 illustrates unique value to prize table 1100. Unique value to prize table 1100 includes a plurality of records 1201. Each record 1201 comprises unique value field 1203 and prize field 1204. Each of the unique value fields 1203 taken together make up all of the possible unique values for a given event, and each of the prize fields 1204 contains representations of the corresponding prizes, if any. Custom written database software 1205, referred to as a stored procedure in the SQL Server® product, searches in table 1100 for the unique value provided through the Internet 303 by the event attendee 201 by examining unique value field 1203 of each record 1201. When that unique value is found, database software 1205 identifies and retrieves the representation of the prize from prize field 1204 associated with that unique value. The specific prize information is incorporated into a preset series of HTML instructions including graphics information that is transmitted to computer 301 through the Internet 303 to create prize web page 1102 on browser 302. Many levels of prizes may exist, such as a grand prize, first place prize, second place prize and common prize, all of differing relative value. Alternatively, all unique values may correspond to one level of prize, or only certain unique values may correspond to a prize.

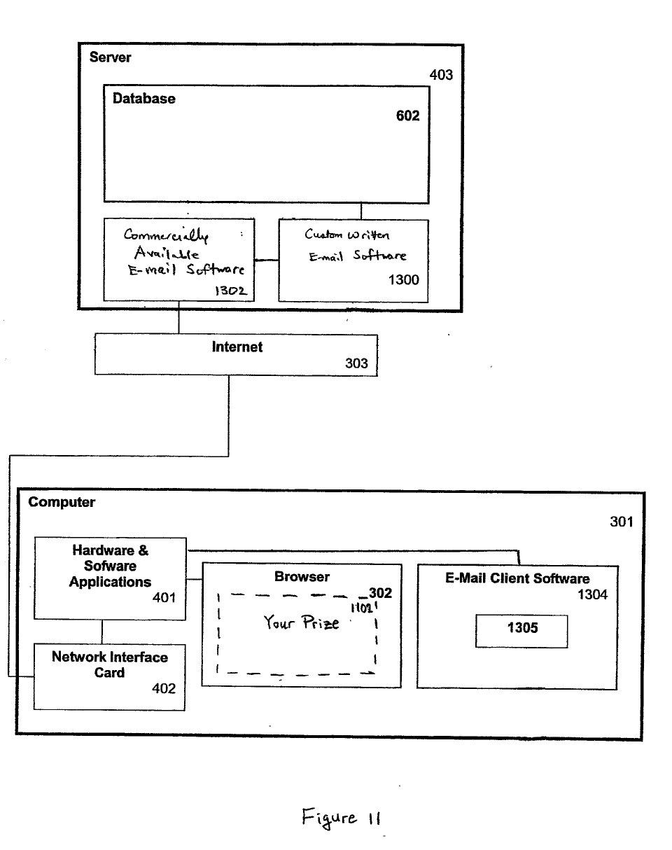

Referring to FIG. 11, custom written e-mail software 1300 and commercially available e-mail software 1302 may be installed on server 403 according to an alternate embodiment of the present invention. Custom written e-mail software 1300 extracts the name and e-mail address of the most recently registered event attendee, for illustrative purposes event attendee 201, from database 602 and combines that name and e-mail address with relevant message content to create e-mail message 1305 in a form appropriate for commercially available e-mail software 1302. The relevant message content may include a thank you for participating in the promotion, instructions regarding redeeming a prize, a code to be used when redeeming the prize online or elsewhere, or hyperlinks to web sites relevant to the prize or the promotion. Also, a hyperlink to an unsubscribe web page may be included, which when completed removes the event attendee's permission to send further e-mail correspondence. Server 403, and in particular commercially available e-mail software 1302, transmits e-mail message 1305 to computer 301 through the Internet 303. A suitable example of commercially available e-mail software 1302 is Microsoft Exchange distributed by Microsoft Corporation of Redmond, Wash.

Server 403 may be provided with software adapted to manage problems in delivering e-mail messages, commonly referred to as bounce backs. A hard bounce back results from an expired or invalid e-mail address in which case server 403 will receive a message indicating that the e-mail address cannot be found. In the case of a hard bounce back, database 602 is modified to remove the e-mail address so that e-mail messages are not sent to that e-mail address in the future. A soft bounce back occurs when server 403 receives a message indicating that the server associated with the e-mail address in question is not available or a message indicating that the recipient is away for a period of time, such as on vacation, and will not be checking e-mail messages. In the case of a soft bounce back, the e-mail address is stored and the message is resent at a later time. An example of commercially available software for performing this function is BoldFish Express Server distributed by BoldFish, Inc. of Santa Clara, Calif.

Computer 301 may include e-mail client software 1304. A suitable example of e-mail client software 1304 is Microsoft Outlook® distributed by Microsoft Corporation located in Redmond, Wash., or Novell® GroupWise 6 distributed by Novell, Inc. of Provo, Utah. Event attendee 201, through use of e-mail client software 1304, is able to open and read e-mail message 1305. Both text-based e-mail technology and HTML-based e-mail technology may be used. E-mail message 1305 may contain either a thank you from the sponsor or another organization, or instructions for redeeming the prize corresponding to the unique value on event attendee 201's event access document. E-mail message 1305 may also contain hyperlinks to the sponsor's or other third party websites.

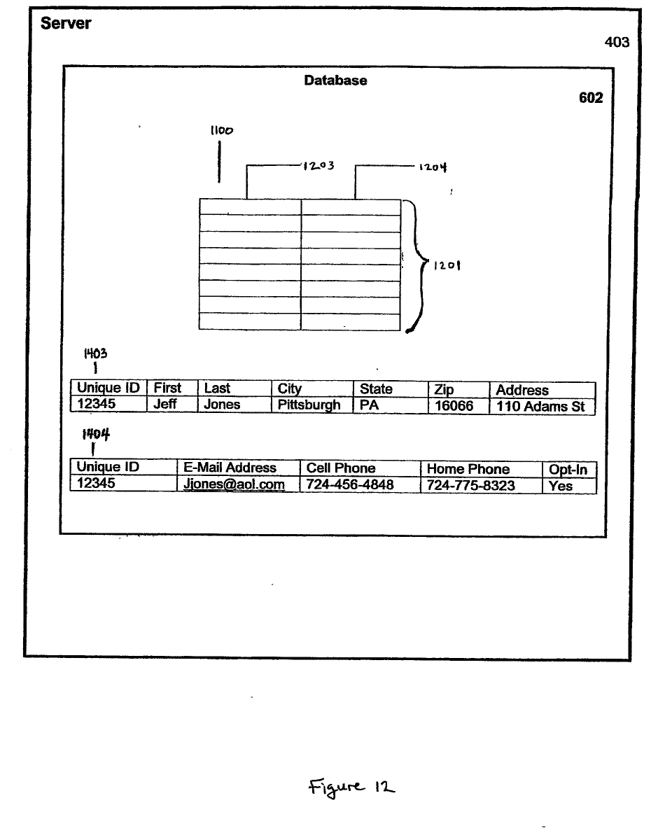

Database 602 includes a personal information table that stores the personal information provided by each event attendee when submitting information in connection with registration web page 501. An example record 1403 of the personal information table is shown in FIG. 12. Database 602 also includes a communication information table that stores the communications information for each event attendee, such as e-mail address, cell phone number, home phone number, and a flag indicating the event attendee's permission to be contacted, also provided when submitting information in connection with registration web page 501. An example record 1404 of the communication information table is shown in FIG. 12. Each event attendee is assigned a unique ID Number, and the information in the personal information table is related to the information in the communication information table by the unique ID number. Database 602 of the present invention may contain more or less database tables, which may store differing categories of information, based on the data storage needs dictated by the particular implementation of the present invention.

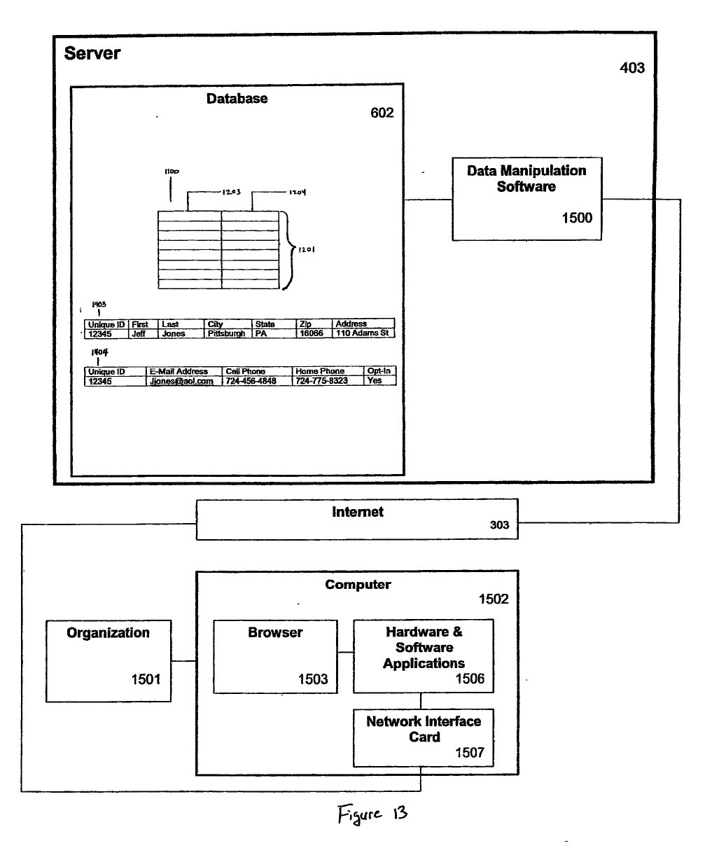

FIG. 13 shows a system for reporting information stored in database 602 to one or more authorized organizations, such as organization 1501, according to an alternate embodiment of the present invention. As seen in FIG. 13, custom written data manipulation software 1500 is stored in the memory of server 403. Data manipulation software 1500 is adapted to copy, manipulate, sort, categorize and summarize the data stored in database 602 and create dynamic reports based thereon in response to requests received by server 403 through the Internet 303. Data manipulation software 1500 may be written in any one of many known programming languages, including the SQL, ASP or Active Server Pages, HTML, Java, JavaScript or VBScript programming languages, and preferably utilizes custom written stored procedures, which are custom written database queries stored within database 602.

Organization 1501 uses organization computer 1502 having an organization browser 1503, hardware and software applications 1506, and network interface card 1507, to generate and transmit requests for reports to server 403 over the Internet 303. Reports may be generated by data manipulation software 1500 according to any number of parameters, such as the number of prizes per prize level issued or the number of event attendees registering and when they registered. Data manipulation software 1500, upon receipt of a request, examines database 602 to determine the correct information to be returned to organization 1501 in the form of a dynamic report. Each dynamic report is compiled by data manipulation software 1500 and sent to organization computer 1502 through the Internet 303, where it can be viewed by using organization browser 1503. The reports generated by data manipulation software 1500 are considered dynamic because they are compiled using information current in database 602 at the exact time the report request is made. As a result, each report may contain completely different information, based on the parameters selected by organization 1501 and the time the report is requested.

The terms and expression which have been employed herein are used as terms of description and not as limitation, and there is no intention in the use of such terms and expressions of excluding equivalents of the features shown and described or portions thereof, it being recognized that various modifications are possible within the scope of the invention claimed. Although particular embodiments of the present invention have been illustrated in the foregoing detailed description, it is to be further understood that the present invention is not to be limited to just the embodiments disclosed, but that they are capable of numerous rearrangements, modifications and substitutions.

What is claimed is:

1. A method of collecting contact information for a plurality of individuals and permission to contact said individuals, comprising:
issuing a plurality of event access documents, said event access documents providing access to an event, each of said event access documents having a unique value provided thereon;
providing notice to a plurality of attendees attending said event that the unique value provided on one or more of said event access documents may be used to collect a prize and instructing said attendees to visit a specified website to determine prize eligibility;
collecting information from each of said attendees visiting said specified website, said information comprising contact information for the website visiting attendee, a grant or denial of permission to contact the website visiting attendee, and the unique value provided on the event access document used by the website visiting attendee;
storing at least a part of the collected information; and
informing each of the website visiting attendees of whether the unique value provided on the event access document used by the website visiting attendee entitles that website visiting attendee to collect a prize.

2. A method according to claim 1, said contact information comprising an electronic mail address of the website visiting attendee and said permission comprising permission to contact the website visiting attendee by electronic mail.

3. A method according to claim 1, said contact information comprising a telephone number of the website visiting attendee and said permission comprising permission to contact the website visiting attendee by telephone.

4. A method according to claim 1, said contact information comprising a street address of the website visiting attendee and said permission comprising permission to contact the website visiting attendee by physical mail.

5. A method according to claim 1, wherein the unique value provided on each of said event access documents may be used to collect a prize, said informing step further comprising informing each of the website visiting attendees of a prize corresponding to the unique value provided on the event access document used by the website visiting attendee.

6. A method according to claim 5, wherein the prizes corresponding to each of the unique values fall into two or more categories.

7. A method according to claim 1, further comprising the steps of evaluating the information collected from each of said website visiting attendees against variable criteria and sending an error message to any said website visiting attendee from which information not meeting said variable criteria was collected.

8. A method according to claim 1, further comprising the steps of evaluating the information collected from each of said website visiting attendees and sending a duplicate information message to any said website visiting attendee from which duplicate information was collected.

9. A method according to claim 1, further comprising the step of providing redemption data to each of the website visiting attendees entitled to collect a prize, said redemption data indicating how the prize corresponding to the event access document used by the website visiting attendee can be redeemed.

10. A method according to claim 9, said redemption data including a hyperlink to a redemption web page through which the prize can be redeemed.

11. A method according to claim 1, said storing step further comprising storing said at least a part of the collected information in a relational database.

12. A method according to claim 1, said collecting step further comprising providing data for creating a registration web page to each of said website visiting attendees, said registration web page being adapted to facilitate the input of said information by the website visiting attendee.

13. A method according to claim 12, said registration web page comprising one or more text boxes and a submit button.

14. A method according to claim 1, said informing step further comprising providing data for creating a prize web page to each of said website visiting attendees entitled to collect a prize, said prize web page being adapted to display the prize corresponding to the unique number provided on the event access document used by the website visiting attendee.

15. A method according to claim 14, each said prize web page including redemption data indicating how the displayed prize can be redeemed.

16. A method according to claim 15, said redemption data including a hyperlink to a redemption web page through which the displayed prize can be redeemed.

17. A method of collecting contact information for a plurality of individuals and permission to contact said individuals, comprising:
providing a website accessible over an electronic network;
collecting information from each of a plurality of event attendees visiting said website, said event attendees having attended an event and having used an event access document having a unique value provided thereon to gain access to said event, said information including contact information for the event attendee, a grant or denial of permission to contact the event attendee, and the unique value provided on the event access document used by the event attendee;
storing at least a part of said information for each said event attendee; and
informing each of said event attendees of whether the unique value provided on the event access document used by the event attendee entitles the event attendee to collect a prize.

18. A method according to claim 17, said contact information comprising an electronic mail address of the event attendee and said permission comprising permission to contact the event attendee by electronic mail.

19. A method according to claim 17, said contact information comprising a telephone number of the event attendee and said permission comprising permission to contact the event attendee by telephone.

20. A method according to claim 17, said contact information comprising a street address of the event attendee and said permission comprising permission to contact the event attendee by physical mail.

21. A method according to claim 17, said collecting step further comprising providing one or more registration web pages to each of said event attendees, said one or more registration web pages being adapted to receive said information, wherein the event attendee inputs said information into said one or more registration web pages.

22. A method according to claim 17, wherein the unique value provided on the event access document used by each of said event attendees may be used collect a prize, said informing step further comprising informing each of said event attendees of a prize corresponding to the unique value provided on the event access document used by the event attendee.

23. A method according to claim 21, wherein the prizes corresponding to each of the unique values fall into two or more categories.

24. A method according to claim 17, further comprising the steps of evaluating the information collected from each of the event attendees against variable criteria and providing an error web page to any of said event attendees from which information not meeting said variable criteria was collected.

25. A method according to claim 17, further comprising the steps of evaluating the information collected from each of the event attendees and providing a duplicate information web page to any of the event attendees from which duplicate information has been collected.

26. A method according to claim 17, further comprising the step of providing a prize web page to each of the event attendees entitled to collect a prize, said prize web pages including redemption data indicating how the prize can be redeemed.

27. A method according to claim 26, said redemption data including a hyperlink to a redemption web page through which the prize can be redeemed.

28. A method according to claim 17, said storing step further comprising storing said at least a part of the collected information for each said event attendee in a relational database.

29. A method according to claim 17, further comprising the step of providing redemption data to each of the event attendees entitled to collect a prize, said redemption data indicating how the prize can be redeemed.

30. A method according to claim 29, said redemption data including a hyperlink to a redemption web page through which the prize can be redeemed.

31. An apparatus for collecting contact information for a plurality of individuals and permission to contact said individuals, comprising:
one or more servers, said one or more servers hosting a website accessible over an electronic network, said website having one or more registration web pages for collecting information from each of a plurality of event attendees, said event attendees having attended an event and having used an event access document having a unique value provided thereon to gain access to said event, said information including contact information for the event attendee, a grant or denial of permission to contact the event attendee, and the unique value provided on the event access document used by the event attendee;
a database provided in said one or more servers, said database storing at least a part of said collected information and an indication for each of said unique values of whether the unique value corresponds to a prize;
said one or more servers informing each of said event attendees of whether the unique value provided on the event access document used by the event attendee corresponds to a prize.

32. An apparatus according to claim 31, said website having one or more prize web pages for informing each of said event attendees of whether the unique value provided on the event access document used by the event attendee corresponds to a prize.

33. An apparatus according to claim 32, wherein the unique value provided on each of said event access documents corresponds to a prize.

34. An apparatus according to claim 33, wherein the prizes corresponding to each of the unique values fall into two or more categories.

35. An apparatus according to claim 33, wherein said one or more prize web pages provided to each of said event attendees includes redemption data indicating how the corresponding prize can be redeemed.

36. An apparatus according to claim 35, said redemption data including a hyperlink to a redemption web page through which the corresponding prize can be redeemed.

37. An apparatus according to claim 31, said one or more servers having electronic mail software, said one or more servers generating and transmitting to each of said event attendees an electronic mail message informing the event attendee of whether the unique value provided on the event access document used by the event attendee corresponds to a prize.

38. An apparatus according to claim 37, wherein the unique value provided on each of said event access documents corresponds to a prize.

39. An apparatus according to claim 38, wherein the prizes corresponding to each of the unique values fall into two or more categories.

40. An apparatus according to claim 38, wherein said electronic mail message includes redemption data indicating how the corresponding prize can be redeemed.

41. An apparatus according to claim 40, said redemption data including a hyperlink to a redemption web page through which the corresponding prize can be redeemed.

42. An apparatus according to claim 31, said contact information comprising an electronic mail address of the event attendee and said permission comprising permission to contact the event attendee by electronic mail.

43. An apparatus according to claim 31, said contact information comprising a telephone number of the event attendee and said permission comprising permission to contact the event attendee by telephone.

44. An apparatus according to claim 31, said contact information comprising a street address of the event attendee and said permission comprising permission to contact the event attendee by physical mail.

45. An apparatus according to claim 31, said one or more servers having data evaluation software, said data evaluation software being adapted to evaluate the information collected from each of said event attendees against variable criteria and send an error message to any said event attendee from which information not meeting said variable criteria was collected.

46. An apparatus according to claim 45, said data evaluation software being further adapted to evaluate the information collected from each of said event attendees and send a duplicate information message to any said event attendee from which duplicate information was collected.

47. An apparatus according to claim 31, said database comprising a relational database management system.

48. A method of collecting contact information for a plurality of individuals and permission to contact said individuals, comprising:
collecting information from each of a plurality of event attendees over an electronic network, said event attendees having attended an event and having used an event access document having a unique value provided thereon to gain access to said event, said information including contact information for the event attendee, a grant or denial of permission to contact the event attendee, and the unique value provided on the event access document used by the event attendee;
storing at least a part of said information for each said event attendee; and
informing each of said event attendees over said electronic network of whether the unique value provided on the event access document used by the event attendee entitles the event attendee to collect a prize.

49. A method according to claim 48, said contact information comprising an electronic mail address of the event attendee and said permission comprising permission to contact the event attendee by electronic mail.

50. A method according to claim 48, said contact information comprising a telephone number of the event attendee and said permission comprising permission to contact the event attendee by telephone.

51. A method according to claim 48, said contact information comprising a street address of the event attendee and said permission comprising permission to contact the event attendee by physical mail.

52. A method according to claim 48, wherein the unique value provided on the event access document used by each of said event attendees may be used collect a prize, said informing step further comprising informing each of said event attendees of a prize corresponding to the unique value provided on the event access document used by the event attendee.

53. A method according to claim 52, said informing step further comprising providing redemption data to each of said event attendees indicating how the corresponding prize can be redeemed.

54. A method according to claim 52, wherein the prizes corresponding to each of the unique values fall into two or more categories.

55. A method according to claim 48, further comprising the steps of evaluating the information collected from each of the event attendees against variable criteria and providing an error message over said electronic network to any of said event attendees from which information not meeting said variable criteria was collected.

56. A method according to claim 48, further comprising the steps of evaluating the information collected from each of the event attendees and providing a duplicate information message over said electronic network to any of the event attendees from which duplicate information has been collected.

57. A method according to claim 48, said storing step further comprising storing said at least a part of the collected information for each said event attendee in a relational database.

58. A method according to claim 48, further comprising the step of providing redemption data to each of the event attendees entitled to collect a prize, said redemption data indicating how the prize can be redeemed.

59. A method according to claim 48, further comprising the step of providing one or more servers, said one or more servers being adapted to perform said collecting, storing and performing steps.

60. A method according to claim 59, said step of providing one or more servers further comprising providing said one or more servers with a relational database management system.

61. An apparatus for collecting contact information for a plurality of individuals and permission to contact said individuals, comprising:
one or more servers accessible over an electronic network, said one or more servers being adapted to collect information from each of a plurality of event attendees, said event attendees having attended an event and having used an event access document having a unique value provided thereon to gain access to said event, said information including contact information for the event attendee, a grant or denial of permission to contact the event attendee, and the unique value provided on the event access document used by the event attendee;
a database provided in said one or more servers, said database storing at least a part of said collected information and an indication for each of said unique values of whether the unique value corresponds to a prize;
said one or more servers informing each of said event attendees over said electronic network of whether the unique value provided on the event access document used by the event attendee corresponds to a prize.

62. An apparatus according to claim 61, wherein the unique value provided on each of said event access documents corresponds to a prize.

63. An apparatus according to claim 62, wherein the prizes corresponding to each of the unique values fall into two or more categories.

64. An apparatus according to claim 61, said one or more servers providing redemption data to each of said event attendees over said electronic network, said redemption data indicating how the corresponding prize can be redeemed.

65. An apparatus according to claim 61, said one or more servers having electronic mail software, said one or more servers generating and transmitting to each of said event attendee an electronic mail message informing the event attendee of whether the unique value provided on the event access document used by the event attendee corresponds to a prize

66. An apparatus according to claim 65, wherein the unique value provided on each of said event access documents corresponds to a prize.

67. An apparatus according to claim 66, wherein the prizes corresponding to each of the unique values fall into two or more categories.

68. An apparatus according to claim 66, wherein said electronic mail message includes redemption data indicating how the corresponding prize can be redeemed.

69. An apparatus according to claim 61, said contact information comprising as electronic mail address of the event attendee and said permission comprising permission to contact the event attendee by electronic mail.

70. An apparatus according to claim 61, said contact information comprising a telephone number of the event attendee and said permission comprising permission to contact the event attendee by telephone.

71. An apparatus according to claim 61, said contact information comprising a street address of the event attendee and said permission comprising permission to contact the event attendee by physical mail.

72. An apparatus according to claim 61, said one or more servers having data evaluation software, said data evaluation software being adapted to evaluate the information collected from each of said event attendees against variable criteria and send an error message over said electronic network to any said event attendee from which information not meeting said variable criteria was collected.

73. An apparatus according to claim 72, said data evaluation software being further adapted to evaluate the information collected from each of said event attendee and send a duplicate information message over said electronic network to any said event attendee from which duplicate information was collected.

74. An apparatus according to claim 61, said database comprising a relational database management system.

75. An apparatus according to claim 31, said one or more servers further comprising means for generating one or more dynamic reports based upon at least a portion of said at least a part of said collected information stored in said database in response to a request from an authorized party.

76. An apparatus according to claim 75, said one or more servers adapted to receive said request from and transmit said one or more dynamic reports to said authorized party over said electronic network.

77. An apparatus according to claim 61, said one or more servers further comprising means for generating one or more dynamic reports based upon at least a portion of said at least a part of said collected information stored in said database in response to a request from an authorized party.

78. An apparatus according to claim 77, said one or more servers adapted to receive said request from and transmit said one or more dynamic reports to said authorized party over said electronic network.

79. A method of collecting contact information for a plurality of individuals and permission to contact said individuals, comprising:
issuing a plurality of event access documents, said event access documents providing access to an event, each of said event access documents having a unique value provided thereon;
providing notice to a plurality of attendees attending said event that the unique value provided on one or more of said event access documents may be used to collect a prize;
providing one or more servers coupled to an electronic network adapted to collect information over said electronic network from one or more information submitting attendees, said information comprising contact information for the information submitting attendee, a grant or denial of permission to contact the information submitting attendee, and the unique value provided on the event access document used by the information submitting attendee;
storing at least a part of the collected information on said one or more servers; and
informing each of the information submitting attendees over said electronic network of whether the unique value provided on the event access document used by the information submitting attendee entitles that information submitting attendee to collect a prize.

80. A method according to claim 79, further comprising hosting a website on said one or mere servers and instructing said attendees to visit said specified website to determine prize eligibility, said website facilitating the collection of said information form said information submitting attendees.

81. A method according to claim 79, said contact information comprising an electronic mail address of the information submitting attendee and said permission comprising permission to contact the information submitting attendee by electronic mail.

82. A method according to claim 79, said contact information comprising a telephone number of the information submitting attendee and said permission comprising permission to contact the information submitting attendee by telephone.

83. A method according to claim 79, said contact information comprising a street address of the information submitting attendee and said permission comprising permission to contact the information submitting attendee by physical mail.

84. A method according to claim 79, wherein the unique value provided on each of said event access documents may be used to collect a prize, said informing step further comprising informing each of the information submitting attendees of a prize corresponding to the unique value provided on the event access document used by the information submitting attendee.

85. A method according to claim 84, wherein the prizes corresponding to each of the unique values fall into two or more categories.

86. A method according to claim 79, further comprising the steps of evaluating the information collected from each of said information submitting attendees against variable criteria and sending an error message over said electronic network to any said information submitting attendee from which information not meeting said variable criteria was collected.

87. A method according to claim 79, further comprising the steps of evaluating the information collected from each of said information submitting attendees and sending a duplicate information message over said electronic network to any said information submitting attendee from which duplicate information was collected.

88. A method according to claim 79, further comprising the step of providing redemption data over said electronic network to each of the information submitting attendees entitled to collect a prize, said redemption data indicating how the prize corresponding to the event access document used by the information submitting attendee can be redeemed.

89. A method according to claim 88, said redemption data including a hyperlink to a redemption web page through which the prize can be redeemed.

90. A method according to claim 79, said storing step further comprising storing said at least a part of the collected information in a relational database provided on said one or more servers.

91. A method according to claim 1, said collecting step further comprising providing data for creating a registration web page to each of said information submitting attendees, said registration web page being adapted to facilitate the input of said information by the information submitting attendee.

92. A method according to claim 91, said registration web page comprising one or more text boxes and a submit button.

93. A method according to claim 79, said informing step further comprising providing data for creating a prize web page to each of said information submitting attendees entitled to collect a prize, said prize web page being adapted to display the prize corresponding to the unique number provided on the event access document used by the information submitting attendee.

94. A method according to claim 93, each said prize web page including redemption data indicating how the displayed prize can be redeemed.

95. A method according to claim 94, said redemption data including a hyperlink to a redemption web page through which the displayed prize can be redeemed.

96. A method according to claim 80, said website having one or more prize web pages for informing each of said information submitting attendees of whether the unique value provided on the event access document used by the information submitting attendee corresponds to a prize.

97. A method according to claim 96, wherein the unique value provided on each of said event access documents corresponds to a prize.

98. A method according to claim 97, wherein the prizes corresponding to each of the unique values fall into two or more categories.

99. A method according to claim 96, wherein said one or more prize web pages provided to each of said information submitting attendees includes redemption data indicating how the corresponding prize can be redeemed.

100. A method according to claim 99, said redemption data including a hyperlink to a redemption web page through which the corresponding prize can be redeemed.

101. A method according to claim 79, further comprising providing said one or more servers with electronic mail software and generating and transmitting to each of said information submitting attendees an electronic mail message informing the information submitting attendee of whether the unique value provided on the event access document used by the information submitting attendee corresponds to a prize.

102. A method according to claim 101, wherein the unique value provided on each of said event access documents corresponds to a prize.

103. A method according to claim 102, wherein the prizes corresponding to each of the unique values fall into two or more categories.

104. A method according to claim 102, wherein said electronic mail message includes redemption data indicating how the corresponding prize can be redeemed.

105. A method according to claim 104, said redemption data including a hyperlink to a redemption web page through which the corresponding prize can be redeemed.

106. A method according to claim 79, further comprising providing said one or more servers with data evaluation software, said data evaluation software being adapted to evaluate the information collected from each of said information submitting attendees against variable criteria and send an error message over said electronic network to any said information submitting attendee from which information not meeting said variable criteria was collected.

107. A method according to claim 106, said data evaluation software being further adapted to evaluate the information collected from each of said information submitting attendees and send a duplicate information message over said electronic network to any said information submitting attendee from which duplicate information was collected.

108. A method according to claim 79, further comprising providing said one or more servers with a relational database management system.
